(19) United States
(12) Patent Application Publication
(10) Pub. No.: US 2019/0135604 A1
(43) Pub. Date: May 9, 2019

(54) WALL-MOUNTED CORKSCREW

(71) Applicant: BOJ OLANETA, S.L.U., Eibar (Guipuzcoa) (ES)

(72) Inventor: Santiago OLANETA ARAMBERRI, Eibar (Guipuzcoa) (ES)

(21) Appl. No.: 16/096,186

(22) PCT Filed: Apr. 10, 2017
(86) PCT No.: PCT/ES2017/070220

§ 371 Date: Oct. 24, 2018

(30) Foreign Application Priority Data
Apr. 26, 2016 (ES) P201630529

(51) Int. Cl. B67B 7/04

(52) U.S. Cl. CPC B67B 7/0452

(57) ABSTRACT

The invention relates to a wall-mounted corkscrew comprising a lever (1), a pull part (2), and a tubular body (3), wherein the pull part (2) can be moved inside the tubular body (3) upon actuation of the lever (1); and a nut (12) which can be moved by the tubular body (3) relative to the pull part (2). In addition, the wall-mounted corkscrew comprises coupling means designed to establish a snap-fit connection between the nut (12) and the pull part (2).

### FIELD OF THE ART

The present invention relates to the industry dedicated to corkscrews, and more particularly to the industry dedicated to wall-mounted, manually actuated corkscrews.

### STATE OF THE ART

Wall-mounted corkscrews which facilitate uncorking bottles are known today. The force, skill, and time to be used in opening or uncorking bottles are reduced by means of wall -mounted corkscrews. Patent document ES2378141T3 discloses an example of said wall-mounted corkscrews.

A lever in wall-mounted corkscrews can be actuated so that a pull part performs a first linear movement in one direction inside a tubular body. The tubular body includes side grooves extending in a longitudinal direction thereof for transmitting the actuation of the lever to the pull part.

When said pull part is moved, a helical shaft is in turn driven for the insertion thereof into a cork housed in a bottle neck. The helical shaft can be moved by the pull part by means of a screw. The movement of the pull part also leads to the movement of the screw, and the movement of the screw tends to lead, in turn, to the movement of a nut. The nut is moved by the action of the screw until the latter contacts a stop element, which results in rotation of the screw and, accordingly, of the helical shaft for its insertion into the cork.

After the insertion of the helical shaft into the cork, the lever can be actuated so that the pull part performs a second linear movement inside the tubular body in another direction which is opposite the preceding direction. The helical shaft is pulled with this movement of the pull part, with the bottle being uncorked as a result.

Likewise, the second linear movement of the pull part tends to drive the nut through the action of the screw. The subsequent movement of the nut is prevented when rods connected to the nut contact a blind end of the tubular body towards which the pull part moves during the mentioned second linear movement. After this contact, the pull part continues to move towards said blind end of the tubular body so that it is secured by means of a magnet located at said end. When the pull part is secured by the magnet, the wall-mounted corkscrew is in the situation in which it can be used again in the manner described above for uncorking another bottle.

The known wall-mounted corkscrews, however, have at least one significant drawback which prevents suitable use thereof. Said drawback is due to the fact that the nut tends to lock up close to the stop element or even in contact with said stop element over time. This is due mainly to the unwanted entry of particles originating from alcoholic beverages, for example, into the wall-mounted corkscrew.

This is the consequence of the particles entering the inside of the tubular body in an unwanted manner, mainly through the side grooves, being deposited close to, as well as on, the stop element. In that sense, given that the nut is moved through said particle deposition area, it suffers an adhesion or locking effect which makes the subsequent movement thereof towards the end at which the magnet is located difficult or even prevents it.

According to this locking up of the nut, the pull part moves away from the nut, resulting in the subsequent rotation of the helical shaft, which results in the helical shaft coming out of the cork without pulling it, and therefore without uncorking the bottle.

In view of the significant drawback of current wall -mounted corkscrews that has been described, a solution at least with respect to the locking up of the nut close to or in contact with the stop element for repeated and effective use of wall-mounted corkscrews is obviously required.

### OBJECT OF THE INVENTION

The present invention relates to a wall-mounted corkscrew which solves the technical problem that has been described, in addition to providing additional advantages which can be derived below. According to this, the wall -mounted corkscrew comprises a lever, a pull part, and a tubular body, wherein the pull part can be moved inside the tubular body upon actuation of the lever; and a nut which can be moved by the tubular body relative to the pull part.

Additionally, the wall-mounted corkscrew comprises coupling means designed to establish a snap-fit connection between the nut and the pull part. From a contact position between the nut and a stop element limiting the movement of the nut in one direction, the nut is thereby forced to be moved along with the pull part according to another direction.

The coupling means are additionally designed to establish a snap-fit release of the nut from the pull part. A simple and efficient way for using the wall-mounted corkscrew repeatedly is thereby provided.

The coupling means comprise an elastically deformable retention element to enable both snap-fit connection and release. The retention element is housed in a recess comprised in the wall-mounted corkscrew. The recess is designed to house the retention element providing the possibility of the latter being elastically deformed. The coupling means also comprise a protruding element, while the retention element has two flexible legs for gripping the protruding element.

The coupling means can additionally comprise a plate for fixing the retention element to the pull part. In this case, the recess is located in the plate.

### DESCRIPTION OF THE DRAWINGS

FIG. 1 shows a perspective view of an assembled wall -mounted corkscrew object of the present invention.

FIG. 2 shows an exploded view of elements of the wall -mounted corkscrew object of the present invention.

FIGS. 3A and 3B show perspective views of two possible arrangements of a stop element with respect to a nut, both elements being comprised in the wall-mounted corkscrew object of the present invention.

FIGS. 4A and 4B show a plate and a retention element of coupling means comprised in the wall-mounted corkscrew object of the present invention.

FIGS. 5 to 8 show different positions of the wall -mounted corkscrew object of the present invention during the uncorking of a bottle.

### DETAILED DESCRIPTION OF THE INVENTION

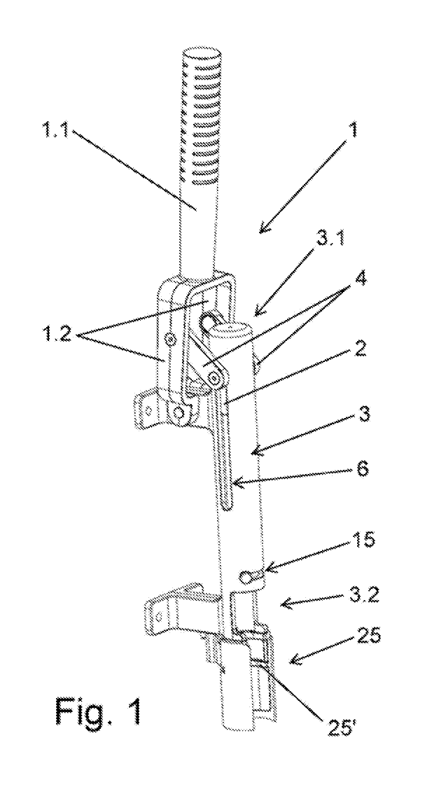

The present invention relates to a wall-mounted corkscrew. The wall-mounted corkscrew that has been assembled, i.e., in usage arrangement, can be seen in FIG. 1. Said wall-mounted corkscrew comprises a lever (1) which includes a handle (1.1) and two arms (1.2) forming a single unit, a pull part (2), and a tubular body (3), such that the pull part (2) can be moved inside the tubular body (3) upon actuation of the lever (1) through the handle (1.1). The lever (1) is connected to the pull part (2) by means of connecting rods (4) and a pin (5). Each of the connecting rods (4) is connected to one of the arms (1.2) and to one end of the pin (5). The pin (5) goes through the pull part (2) transversely and is connected to the connecting rods (4) through side grooves (6) of the tubular body (3).

The wall-mounted corkscrew comprises a magnet (7) at a blind end (3.1) of the tubular body (3) to exert a force for securing the pull part (2), such that when the lever (1) is not actuated, the pull part (2) keeps the distance with respect to said blind end (3.1) constant by means of contact with the magnet (7). For this purpose, the pull part (2) is arranged such that the pin (5) goes through it and the pin (5) comprises a ferromagnetic material.

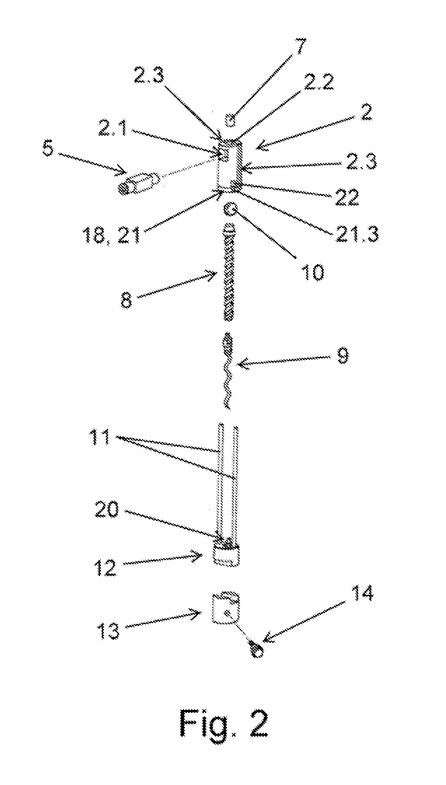

As can be seen in FIG. 2, the pin (5) has a square cross-section, at least in a central portion thereof, intended for contacting the magnet (7) so to provide a larger contact surface, wherein the securing force is therefore more reliable and effective. Additionally, the pull part (2) has a transverse hole (2.1) designed for the insertion and arrangement of the pin (5) therein such that, with the pin (5) inserted in the transverse hole (2.1), said pin (5) is prevented from rotating with respect to its central longitudinal axis.

The pull part (2) also has a longitudinal hole (2.2) in which a screw (8) is secured. The screw (8) is secured to the pull part (2) at one end, with the screw (8) being free to rotate with respect to the central longitudinal axis going through same, and connected to a helical shaft (9), preferably by means of screwing, at the other end. The longitudinal hole (2.2) includes a tapering for securing the screw (8), the screw (8) being separated from the pin (5) by a ball (10) in the usage arrangement. The arrangement of the ball (10) allows rotation of the screw (8) with respect to its central longitudinal axis during usage of the wall-mounted corkscrew.

The wall-mounted corkscrew preferably comprises two rods (11) and a nut (12), each of the rods (11) being arranged fixed at a longitudinal end to the nut (12) for the guiding thereof in the tubular body (3) through longitudinal grooves (2.3) which the pull part (2) has for such purpose. Likewise, the rods (11) limit the movement of the nut (12) towards said blind end (3.1) by means of contact with said blind end (3.1) of the tubular body (3).

The nut (12) can also be moved towards an open end (3.2) of the tubular body (3). To limit the movement of the nut (12) towards said open end (3.2), the wall-mounted corkscrew comprises a stop element (13), as well as a tightening element (14) for fixing the stop element (13) according to different relative positions with respect to the tubular body (3). According to the positions in which the stop element (13) is fixed with respect to the tubular body (3), different limits of movement of the nut (12) are established.

The tightening element (14) has a threaded end (14.1) for being screwed in the stop element (13) through an opening (15) included in the tubular body (3), in addition to a gripping end (14.2) the dimensions of which are larger than the opening (15). According to this, the tightening element (14) is designed to be rotated by means of the gripping end (14.2), with it being tightened against the tubular body (3) to fix the position of the stop element (13). The opening (15) is in turn designed for an angular movement of the tightening element (14), with said tightening element being contained on a single plane (not shown in the drawings) and partially screwed into the stop element (13). Preferably, a central longitudinal axis of the tubular body (3) is perpendicular to said plane containing the tightening element (14).

According to one embodiment, in order to establish the different limits of movement of the nut (12), the wall-mounted corkscrew comprises a housing (16) and a protuberance (17).

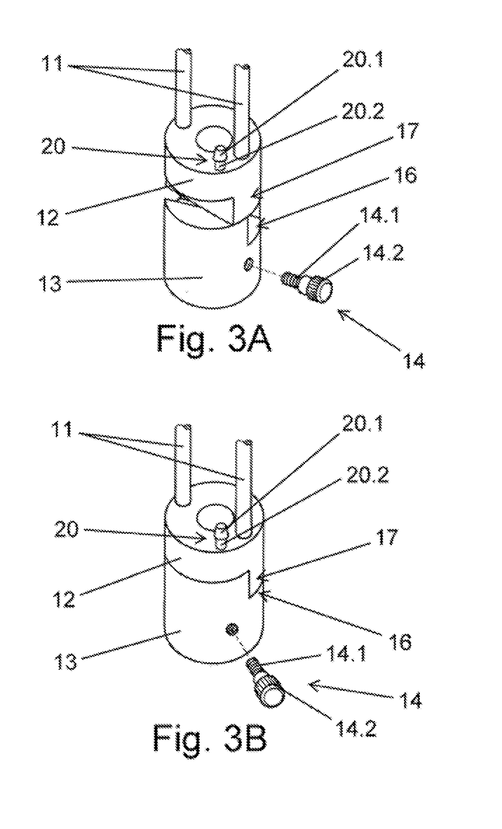

The housing (16), which can be seen in FIG. 2, is designed for receiving the protuberance (17). In this manner, there are two established limits of movement, a first limit when the protuberance (17) is housed in the housing (16), as seen in FIG. 3B, and a second limit when the protuberance (17) contacts the stop element (13), preventing it from being able to be housed in the housing (16), as seen in FIG. 3A. Preferably, the housing (16) is arranged in the stop element (13) and the protuberance (17) is arranged in the nut (12), although this could alternatively be the other way around.

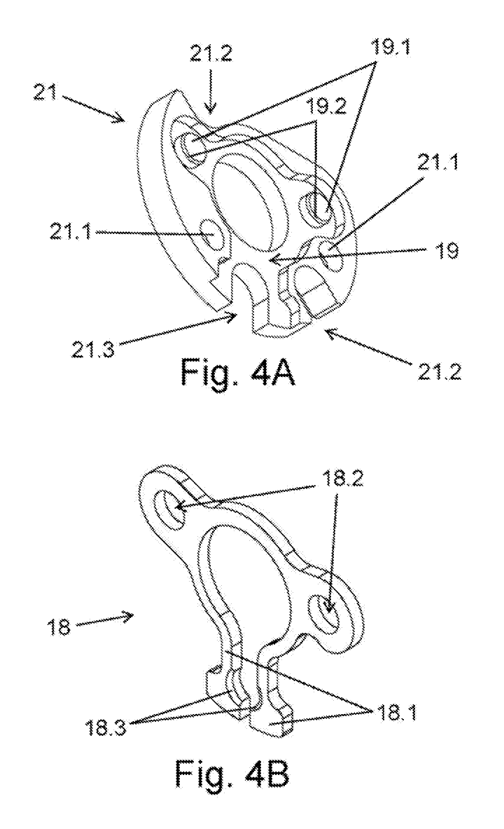

On the other hand, the wall-mounted corkscrew comprises coupling means designed to establish a snap-fit connection between the nut (12) and the pull part (2). To carry out said connection, the coupling means comprise an elastically deformable retention element (18). As can be seen in FIG. 4B, the retention element (18) has two flexible legs (18.1) to establish said snap-fit by means of separating from one another. The two legs (18.1) extend from fitting holes (18.2) which the retention element (18) has for the placement thereof. Said retention element (18) preferably has a planar configuration such that it takes up little space in the tubular body (3) according to the longitudinal extension thereof.

The wall-mounted corkscrew comprises a recess (19) for receiving the retention element (18). The retention element (18) is preferably arranged such that it is completely embedded in the recess (19), at least with respect to the thickness thereof, for its protection. The recess (19) has fitting protrusions (19.1) complementary with the fitting holes (18.2) for placing the retention element (18) by press -fitting. The fitting protrusions (19.1) include elastic elements (19.2) for the quick and simple removable fitting of the retention element (18) in the recess (19). The elastic elements (19.2) are circular rubbers or washers. This configuration facilitates maintenance and replacement of the retention element (18).

On the other hand, the coupling means additionally comprise a protruding element (20) for the snap-fit connection between the nut (12) and the pull part (2). The protruding element (20) has a head (20.1) and an elongated body (20.2).

Said protruding element (20) can be seen in FIGS. 2, 3A, and 3B. By establishing the snap-fit connection between the nut (12) and the pull part (2), the retention element (18) is at least partially surrounding the elongated body (20.2). To facilitate said arrangement of the retention element (18) at least partially surrounding the elongated body (20.2), the cross-section of the head (20.1) has a progressive reduction in the portion of its free end. The head (20.1) can therefore be inserted through the two legs (18.1) and facilitates the elastic deformation of said legs (18.1) for fitting in the elongated body (20.2) by snap-fitting.

The coupling means are additionally designed to establish a snap-fit release of the nut (12) from the pull part (2). To facilitate taking the two legs (18.1) out of the elongated body (20.2) by means of snap-fitting, the retention element (18) has a bevel (18.3) in each of the two legs (18.1).

The wall-mounted corkscrew preferably comprises a plate (21) which can be seen in FIG. 4A. The plate (21) enables a simple and easy adaptation of conventional wall-mounted corkscrews according to the present invention, and more specifically allows designing them in order to provide them with the snap-fit connection and snap-fit release between the nut (12) and the pull part (2). The recess (19) is thereby located in said plate (21).

According to a preferred embodiment, the retention element (18) is fixed to the pull part (2) and the protruding element (20) is fixed to the nut (12), although alternatively they are arranged the other way around. In both cases, the retention element (18) can be arranged through the plate (21), for which the plate (21) has fixing means (21.1), in addition to areas (21.2) for the passage of the rods (11). The fixing means (21.1) are preferably through holes (21.1) for the placement of the plate (21) by means of conventional screws.

If the recess (19) is located in the plate (21), said plate (21) includes an indentation (21.3) for receiving the protruding element (20) when the snap-fit connection is established between the pull part (2) and the nut (12). According to the longitudinal extension of the protruding element (20), said indentation (21.3) is designed for the passage of the protruding element (20) through the plate (21) in a complete manner, as can be seen in FIG. 4A, or in a partial manner.

Whether or not the retention element (18) is provided by means of the plate (21), the wall-mounted corkscrew can include a blind hole (22) for partially housing the protruding element (20) depending on the longitudinal extension thereof when the snap-fit connection is established between the pull part (2) and the nut (12). According to the description above, the blind hole (22) can be located in the pull part (2), as can be seen in the embodiment shown in the drawings, or in the nut (12).

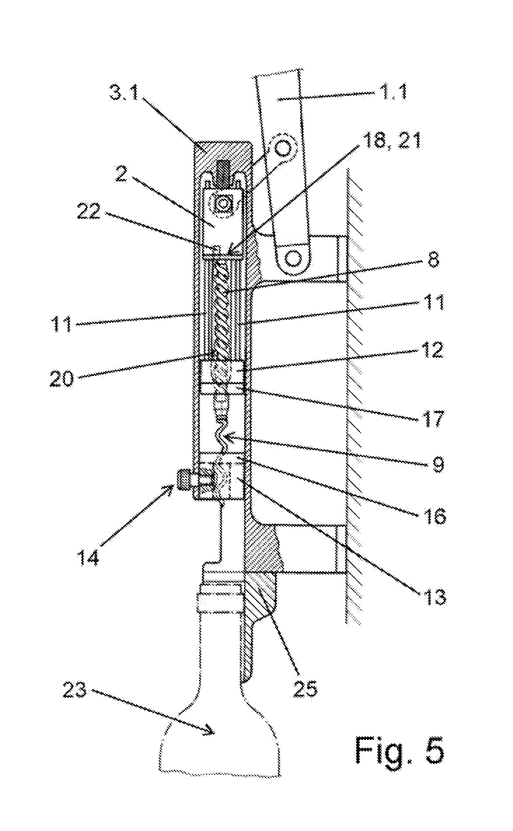

FIGS. 5 to 8 show different positions of the wall -mounted corkscrew during use, i.e., when uncorking a bottle (23), which is not an object of the present invention. In said drawings, some elements or details of some of the elements, such as the ball (10) and the tapering included in the longitudinal hole (2.2) for fixing the screw (8), for example, have been omitted for the sake of clarity.

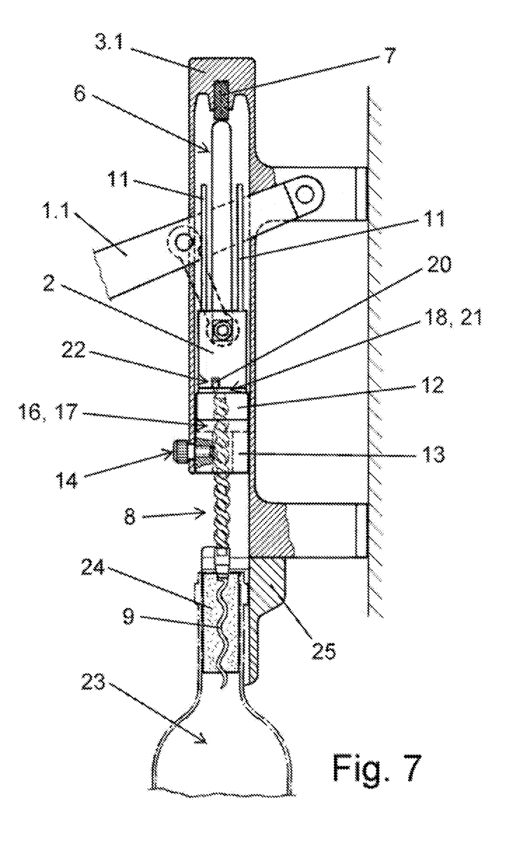

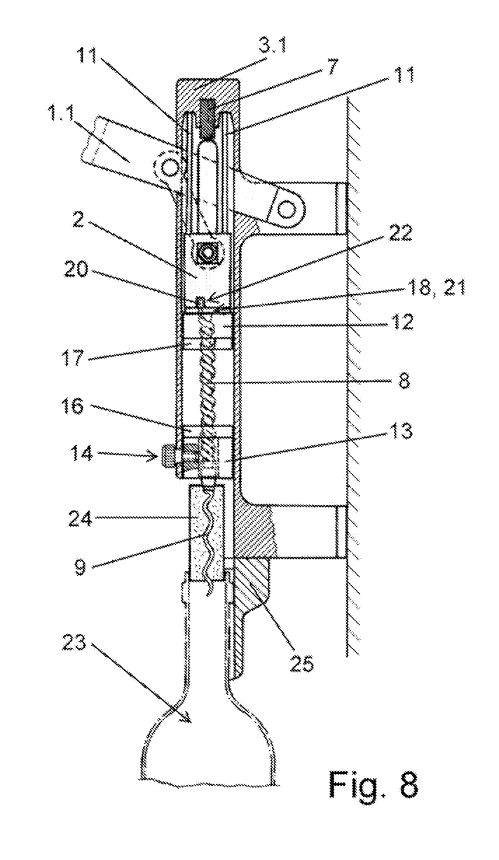

Initially, as shown in FIG. 5, the bottle (23) is arranged in the wall-mounted corkscrew such that the portion containing a cork (24) (included in FIGS. 7 and 8) is arranged in correspondence with a cover (25) comprised in the wall-mounted corkscrew. The cover (25) has an inner rib (25′) designed to axially retain the bottle (23). Additionally, said cover (25) is a single element such that its assembly and disassembly with respect to the rest of the wall-mounted corkscrew, for example for cleaning or replacement, is simplified.

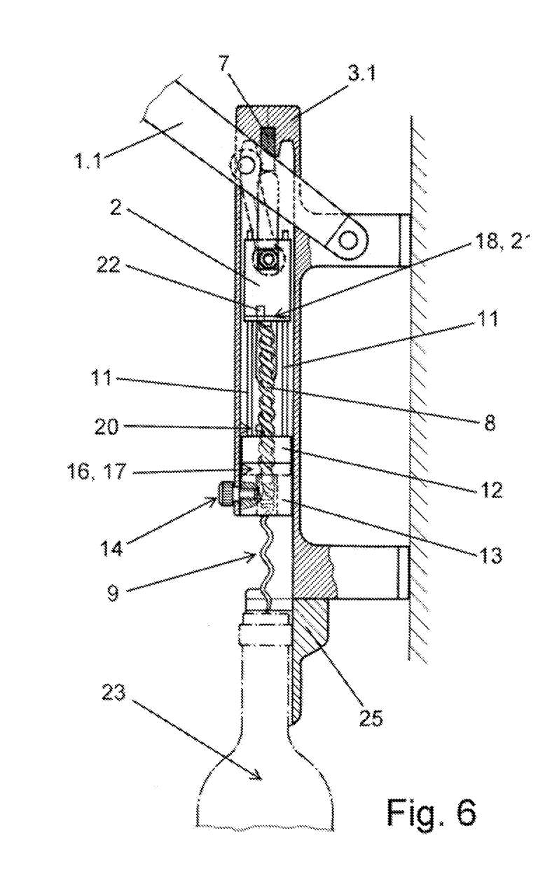

Before starting to uncork the bottle (23), FIG. 5, the relative position of the stop element (13) can be adjusted with respect to the tubular body (3). The established limit of movement of the nut (12) depends on the cork (24) and the bottle (23) such that suitable insertion of the helical shaft (9) into the cork (24) for removing same from the bottle (24) is established. Then, during uncorking, the gripping end (14.2) is in contact with the tubular body (3), blocking the possibility of the stop element (13) rotating with respect to its central longitudinal axis, as can be seen in FIGS. 6 to 8.

With the actuation of the lever (1), the pull part (2) is moved towards the open end (3.2) of the tubular body (3). This movement of the pull part (2) entails the movement of the nut (12), also towards said open end (3.2), through the action of the screw (8). The movement of the screw (8) consists of a linear movement. These movements of the screw (8) and the nut (12) occur until said nut (12) contacts the stop element (13), as shown in FIG. 6.

By means of the lever (1) being continuously actuated towards the open end (3.2), after the nut (12) reaches the limit of movement which has been established, the pull part (2) can continue to move towards the open end (3.2), shortening the separation distance from the nut (12) until contacting said nut (12). In this manner, when the pull part (2) reaches the nut (12), the snap-fit connection between said nut (12) and the pull part (2) is established. Likewise, this movement of the pull part (2), together with the nut (12) the movement of which is blocked, entails the screw (8) being moved according to a joint linear and rotational movement for inserting the helical shaft into the cork (24). FIG. 7 shows an example of the resulting position.

The lever (1) can then be actuated to be moved towards the blind end (3.1) of the tubular body (3), with the subsequent movement of the pull part (2) also towards said blind end (3.1). The snap-fit connection established between the nut (12) and the pull part (2) by means of the coupling means forces the joint movement of the nut (12) and the pull part (2) such that the nut (12) is spaced from the stop element (13). Likewise, the pull part (2) drives the screw (8), the latter being moved only linearly, resulting in turn in the only linear movement of the helical shaft (9) for pulling the cork (24). In this manner, uncorking of the bottle (23) is therefore assured.

As a result of the movement of the nut (12) towards the blind end (3.1), the rods (11) contact the blind end (3.1) by means of their free ends. FIG. 8 shows the position of the wall-mounted corkscrew in which the free ends of the rods (11) are in contact with the blind end (3.1). Then, by means of continuously actuating the lever (1), the snap-fit release of the pull part (2) from the nut (12) is established. This release allows the pull part (2) to move away from the nut (12) towards the magnet (7), in turn pulling the screw (8) such that the screw (8) rotates with respect to its central longitudinal axis through the action of the nut (12) the movement of which is limited to movement towards the blind end (3.1). This rotation of the screw (8), together with the arrangement of the stop element (13), causes the helical shaft (9) to no longer be inserted in the cork (24).

The helical shaft (9) preferably has a circular cross -section. The circular cross-section facilitates insertion of the helical shaft (9) into the cork (24), in turn providing a smaller break in the shaft compared to cross-sections with other geometries.

As a result of the circular cross-section, the helical shaft (9) can come out of the cork (24) without uncorking the bottle (23) as it tends to rotate with respect to its central longitudinal axis. This situation can arise particularly when the corks (24) are made of a synthetic material given that they provide a lower coefficient of friction. However, the snap-fit connection provided by the coupling means solves this drawback by forcing the helical shaft (9) to be moved only linearly, i.e., without rotating with respect to its central longitudinal axis, after said connection has been established.

1. A wall-mounted corkscrew comprising:
a lever, a pull part, and a tubular body, wherein the pull part can be moved inside the tubular body upon actuation of the lever; and
a nut which can be moved by the tubular body relative to the pull part;
comprising:
coupling means designed to establish a snap-fit connection between the nut and the pull part.

2. The wall-mounted corkscrew according to claim 1, wherein the coupling means are additionally designed to establish a snap-fit release of the nut from the pull part.

3. The wall-mounted corkscrew according to claim 1, wherein the coupling means comprise an elastically deformable retention element.

4. The wall-mounted corkscrew according to claim 3, wherein the coupling means comprise a protruding element, the retention element having two flexible legs for gripping the protruding element.

5. The wall-mounted corkscrew according to claim 3, wherein the coupling means comprise a plate for fixing the retention element to the pull part.

6. Wall-mounted corkscrew according to claim 3, further comprising a recess in which the retention element can be housed.
